(19) United States
(12) Patent Application Publication
(10) Pub. No.: US 2020/0096087 A1
(43) Pub. Date: Mar. 26, 2020

(54) SPROCKET

(71) Applicant: TSUBAKIMOTO CHAIN CO., Osaka (JP)

(72) Inventors: Masahiko Konno, Osaka-shi (JP); Shoichiro Shimizu, Osaka-shi (JP)

(73) Assignee: TSUBAKIMOTO CHAIN CO., Osaka (JP)

(21) Appl. No.: 16/567,537

(22) Filed: Sep. 11, 2019

(30) Foreign Application Priority Data
Sep. 20, 2018 (JP) 2018-175967

(51) Int. Cl. F16H 55/14; F16H 55/30

(52) U.S. Cl. CPC F16H 55/14; F16H 55/06; F16H 55/30

(57) ABSTRACT

An object of the present invention is to provide a sprocket that reduces impact and knocking sound of contact or seating when meshing with a chain, and that improves the durability of an entire chain drive system by reducing vibration and noise. The sprocket includes a cushion ring having an outer circumferential surface that is configured to come into contact with link plates of the chain. The cushion ring includes a circumferential groove extending in a circumferential direction on the outer circumferential surface, and the circumferential groove has a width smaller than that of the link plates.

### BACKGROUND OF THE INVENTION

### 1. Field of the Invention

The present invention relates to a sprocket having a plurality of multiple teeth formed on a circumferential surface of the sprocket body, the plurality of teeth being configured to mesh with pins, bushings, or rollers of a chain, and a cushion ring provided on a side surface of the sprocket body and having an outer circumferential surface that is configured to come into contact with link plates of the chain.

### 2. Description of the Related Art

Chain drive systems with a chain passing over at least two sprockets on a drive side and a driven side to transmit power have been widely used, and for whatever uses it is desirable to reduce the noise level.

Noise is largely attributable to the knocking sound caused by pins, bushings, or rollers coming into contact with or being seated on the sprocket teeth at the moment when the chain starts to mesh with the sprocket, and how to reduce this noise is an issue with chain drive systems.

The impact of contact and seating of the pins, bushings, or rollers coming into contact with or being seated on the sprocket teeth at the start of meshing not only causes vibration but also breakage and wear of the chain or sprocket, leading to another issue of durability loss.

Sprockets having a plurality of teeth on a circumferential surface of the sprocket body to mesh with pins, bushings, or rollers of a chain, and a cushion ring provided on a side surface of the sprocket body and having an outer circumferential surface that is configured to come into contact with link plates of the chain, for reducing the impact and knocking noise of contact and seating when the chain meshes with the sprocket, have been known. As the link plates come to contact with the outer circumferential surface of the cushion ring of the sprocket before the pins, bushings, or rollers of the chain contact with or be seated on the sprocket teeth, the impact and knocking noise caused by the meshing are alleviated.

When the sprocket meshes with a roller chain made up of multiple inner link plates and outer link plates alternately coupled together with coupling pins, middle parts in the chain length direction of the link plates come to position closest to the center of the sprocket when the chain passes over the sprocket.

Therefore, parts of the outer circumferential surface of the cushion ring that come to contact with the middle parts in the chain length direction of the link plates, i.e., parts corresponding to the tooth tips of the plurality of teeth in the circumferential direction, make tightest contact with the link plates and undergo a large elastic deformation.

A sprocket provided with grooves with the same pitch as the sprocket teeth on the outer circumferential surface of the cushion ring in order to adjust the elastomeric force and to control the condition of contact between the meshing rollers and the sprocket has been known (see, for example, WO 2017/019814), wherein the outer circumferential surface of the cushion ring between the grooves are inclined with respect to the circumferential surface.

### SUMMARY OF THE INVENTION

The cushion rings of sprockets known for example from WO 2017/019814 are repeatedly compressed/deformed and released/restored as each link plate of the chain contacts and separates when the sprocket rotates with the chain passed over it.

When the cushion ring undergoes compression and deformation, the amount of deformation L0 is particularly large in the cushion ring E as the surface of non-pressed regions, which are positioned on both outer sides in the width direction of a pressed region R that is directly pressed by link plates P, stretches largely as shown in FIG. 19A.

Accordingly, the stress generated inside the cushion ring E becomes excessive in the non-pressed regions, so that cracks C can readily start to form from the edges of the non-pressed regions on the outer sides of the end face of the link plate P, as shown in FIG. 19B. When cracks C formed in the cushion ring E grow, the pressed region R of the cushion ring E pressed by the link plates P becomes hardened in the deformed state, because of which the cushion ring E loses its function and the sound-muffling effect is lost.

Once cracked, the cushion ring may partly flake as the chain plates slide thereon and the sprocket rotates, and contaminate the engine oil, or get into gaps of other components and cause faults.

An object of the present invention is to solve these problems in the prior art and to provide a sprocket that reduces impact and knocking sound of contact or seating when meshing with a chain, and that improves the durability of an entire chain drive system by reducing vibration and noise.

The present invention achieves the above object by providing a sprocket including a sprocket body having a plurality of teeth formed on a circumferential surface thereof, and a cushion ring provided on at least one side surface of the sprocket body and having an outer circumferential surface that is configured to come into contact with link plates of a chain, the cushion ring including a circumferential groove extending in a circumferential direction on the outer circumferential surface, the circumferential groove having a width smaller than a width of the link plates.

According to the sprocket set forth in claim 1, when the cushion ring is pressed by the chain plates, the circumferential groove on the outer circumferential surface of the cushion ring is deformed, so that the amount of deformation (strain) of the cushion ring is reduced, which suppresses the stress generated in the cushion ring. The load applied on the surface of the cushion ring with repeated compression/deformation by the contact with the link plates of the chain and release/restoration is accordingly reduced. Crack formation on the outer circumferential surface of the cushion ring is thus avoided, so that the cushion ring can exhibit its intended functions in a stable manner over a long period. The impact or knocking sound of contact and seating when meshing with the chain can thus be mitigated, as well as vibration and noise of the entire chain drive system can be reduced, whereby the durability can be improved further.

Moreover, since the compressed air when the link plates of the chain hit the cushion ring can be let out from the circumferential groove, the sound-muffling effect can be enhanced. Friction heat that is generated by the sliding movement between the surface of the cushion ring and end faces of the chain link plates can also be readily released outside, so that further thermal degradation of the material forming the cushion ring can be retarded.

Furthermore, the circumferential groove that can readily draw in the engine oil allows for formation of a lasting oil film between end faces of the link plates and the surface of the cushion ring. This oil film can enhance the cushioning effect, as well as reduce the wear of the cushion ring. The oil film also mitigates generation of friction heat, so that further thermal degradation of the material forming the cushion ring can be controlled even more reliably.

The cushion ring is commonly produced by press molding or injection molding. To add the features described above, it is only necessary to provide projections on the metal molds. The ease of changing the shape and the number and position of the circumferential groove to be provided enables production of sprockets as desired without increasing the cost.

According to the sprocket set forth in claims 2 to 7, the amount of deformation of the cushion ring when in contact with link plates of the chain can be reduced even further, so that crack formation on the outer circumferential surface of the cushion ring can be avoided reliably. The impact or knocking sound of contact and seating when meshing with the chain can thus be mitigated, as well as vibration and noise of the entire chain drive system can be reduced, whereby the durability can be improved further.

### BRIEF DESCRIPTION OF THE DRAWINGS

FIG. 1 is a perspective view illustrating one configuration example of a sprocket according to a first embodiment of the present invention;

FIG. 2 is a cross-sectional perspective view illustrating part of the sprocket shown in FIG. 1;

FIG. 3 is a schematic cross-sectional view illustrating essential parts of another configuration example of the sprocket according to the first embodiment of the present invention;

FIG. 4 is a schematic cross-sectional view illustrating essential parts of yet another configuration example of the sprocket according to the first embodiment of the present invention;

FIG. 5A is a conceptual diagram illustrating a state of the cushion ring of the sprocket shown in FIG. 1 before the cushion ring is pressed by a link plate;

FIG. 5B is a conceptual diagram illustrating a compressed and deformed state of the cushion ring of the sprocket shown in FIG. 1;

FIG. 6 is a cross-sectional perspective view illustrating part of a configuration example of a sprocket according to a second embodiment of the present invention;

FIG. 7 is a schematic cross-sectional view illustrating essential parts of the sprocket shown in FIG. 6;

FIG. 8 is a schematic cross-sectional view illustrating essential parts of another configuration example of the sprocket according to the second embodiment of the present invention;

FIG. 9 is a schematic cross-sectional view illustrating essential parts of yet another configuration example of the sprocket according to the second embodiment of the present invention;

FIG. 10 is a cross-sectional perspective view illustrating part of a configuration example of a sprocket according to a third embodiment of the present invention;

FIG. 11 is a schematic cross-sectional view illustrating essential parts of the sprocket shown in FIG. 10;

FIG. 12A is a conceptual diagram illustrating a state of the cushion ring of the sprocket shown in FIG. 9 before the cushion ring is pressed by a link plate;

FIG. 12B is a conceptual diagram illustrating a compressed and deformed state of the cushion ring of the sprocket shown in FIG. 9;

FIG. 13 is a schematic cross-sectional view illustrating essential parts of another configuration example of the sprocket according to the third embodiment of the present invention;

FIG. 14 is a schematic cross-sectional view illustrating essential parts of yet another configuration example of the sprocket according to the third embodiment of the present invention;

FIG. 15 is a schematic cross-sectional view illustrating essential parts of a further configuration example of the sprocket according to the third embodiment of the present invention;

FIG. 16 is a perspective view illustrating one configuration example of a sprocket according to a fourth embodiment of the present invention;

FIG. 17 is a cross-sectional perspective view illustrating part of the sprocket shown in FIG. 16;

FIG. 18 is a cross-sectional perspective view illustrating part of a configuration example of a sprocket according to a fifth embodiment of the present invention;

FIG. 19A is a conceptual diagram illustrating a compressed and deformed state of a cushion ring for explaining a problem with a conventional sprocket; and

FIG. 19B is a conceptual diagram illustrating a crack formed on an outer circumferential surface of a cushion ring for explaining a problem with a conventional sprocket.

### DESCRIPTION OF THE PREFERRED EMBODIMENTS

The sprocket of the present invention may have any specific configuration as long as it includes a sprocket body having a plurality of teeth formed on a circumferential surface thereof, and a cushion ring provided on at least one side surface of the sprocket body and having an outer circumferential surface that is configured to come into contact with link plates of a chain, the cushion ring including a circumferential groove extending in a circumferential direction on the outer circumferential surface, the circumferential groove having a width smaller than a width of the link plates.

The circumferential groove of the cushion ring may continuously extend all around in the circumferential direction, or may be formed intermittently in the circumferential direction at positions where it is pressed by link plates.

Preferably, a plurality of circumferential grooves should be formed in the width direction of the cushion ring, but these plurality of circumferential grooves need not necessarily be formed over the entire area in the width direction. The circumferential grooves need not all have the same size (groove width and groove depth) or the same shape.

In the sprocket of the present invention, preferably, the circumferential groove of the cushion ring should be provided in at least non-pressed regions on both outer sides of a pressed region that is configured to be pressed by the link plates. In such a configuration, there may be just one circumferential groove or a plurality of circumferential grooves disposed in the non-pressed regions, but preferably, the circumferential grooves should be provided in plurality.

In a configuration wherein a circumferential groove is disposed also in the pressed region that is configured to be pressed by the link plates, the circumferential groove disposed in the non-pressed regions should preferably be larger in at least one or both of a groove width and a groove depth than the circumferential grooves disposed in the pressed region.

The sprocket body of the sprocket according to the present invention may be made of any of metals such as steel, ceramics, resins, and so on, or a composite material of these.

The cushion ring of the sprocket according to the present invention may be made of rubber, synthetic resin, or any other materials as long as the material has elasticity and can reduce the sound when contacting with the chain.

The chain passed over the sprocket according to the present invention may be any chain such as a roller chain, a bushing chain, a silent chain and the like, as long as the chain is made up of multiple link plates coupled together by coupling pins so that the chain is flexible.

### First Embodiment

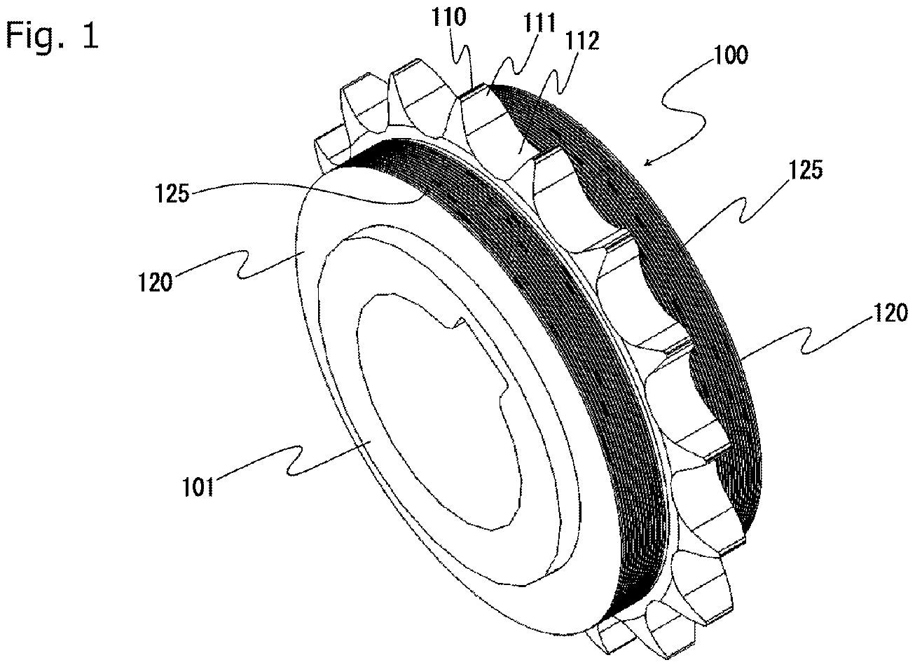

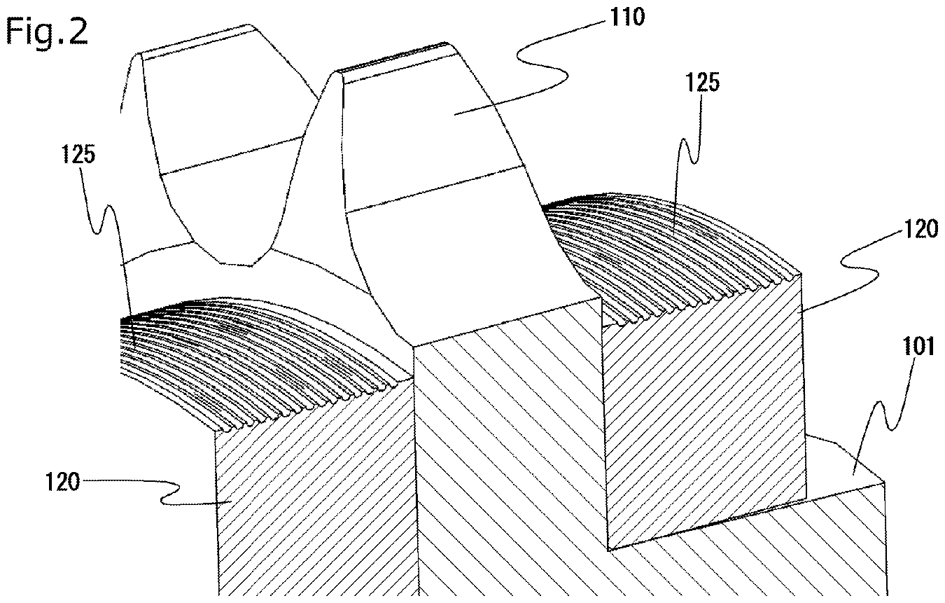

As shown in FIG. 1 and FIG. 2, a sprocket 100, which is a first embodiment of the present invention, includes a sprocket body 101 with multiple teeth 110 formed on a circumferential surface, each tooth having a tooth tip 111 and a tooth bottom 112, and cylindrical cushion rings 120 provided on both side surface of the sprocket body 101, each having an outer circumferential surface that is configured to come into contact with link plates of a chain. The cushion rings 120 are made of an elastic material.

A plurality of circumferential grooves 125 extend circumferentially and continuously all around and side by side in a width direction on the outer circumferential surface of each of the cushion rings 120. These circumferential grooves 125 have the same size (groove width and groove depth) and are disposed at equal distance in the width direction. Some of the circumferential grooves 125 may vary in size.

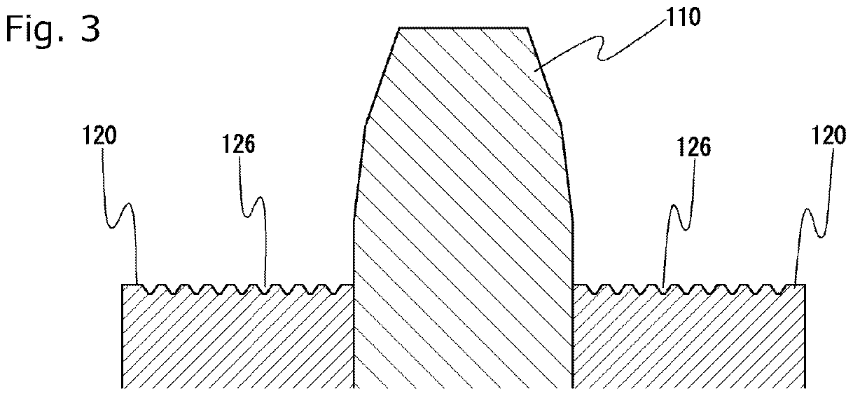

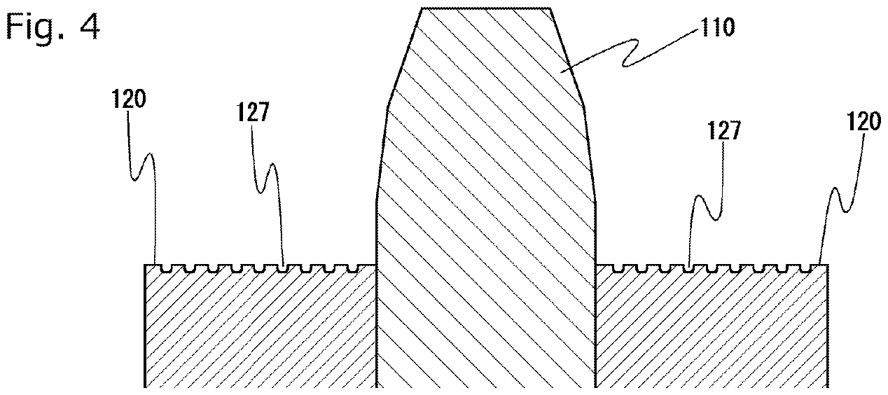

While the circumferential grooves 125 in this example are rounded grooves, cross-sectional shapes of the circumferential grooves 125 may be any cross-sectional shape. For example, as shown in FIG. 3, cross-sectional shapes of the circumferential grooves 126 may be V-groove shapes (triangular), or, as shown in FIG. 4, cross-sectional shapes of the circumferential grooves 127 may be rectangular-groove shapes. The sprockets shown in FIG. 3 and FIG. 4 are the same as the sprocket 100 shown in FIG. 1 except for the cross-sectional shape of the circumferential grooves.

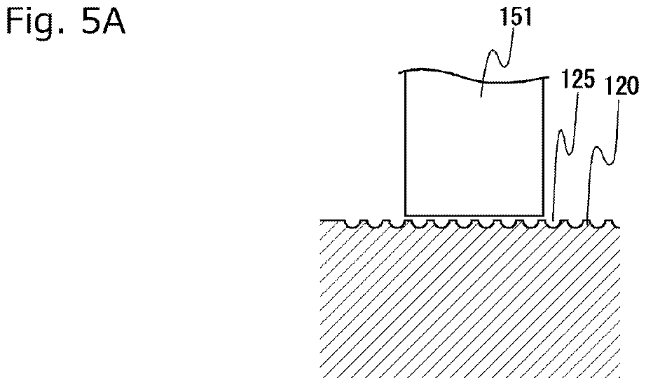

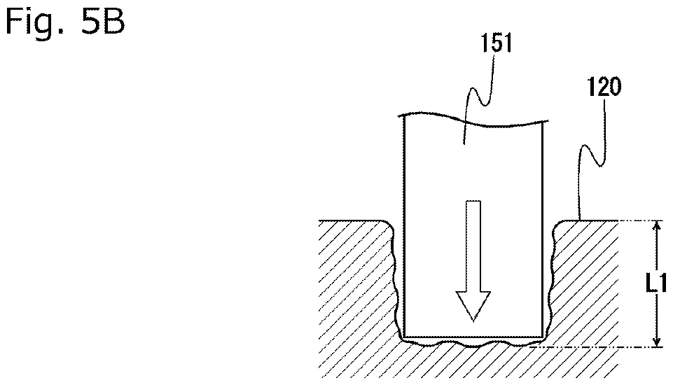

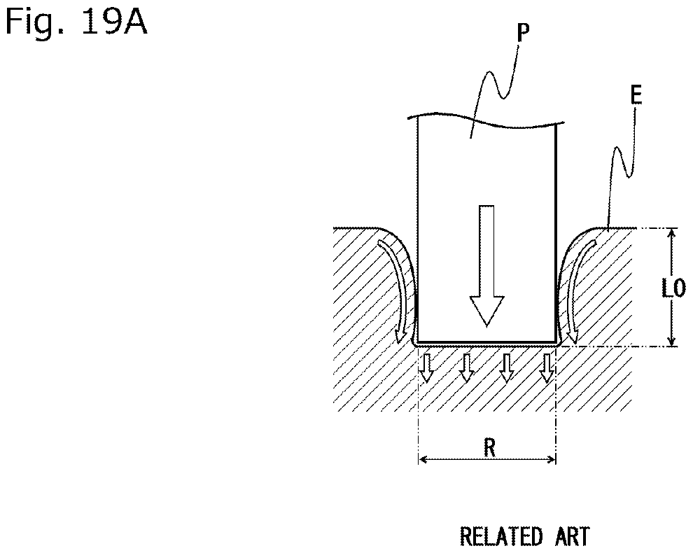

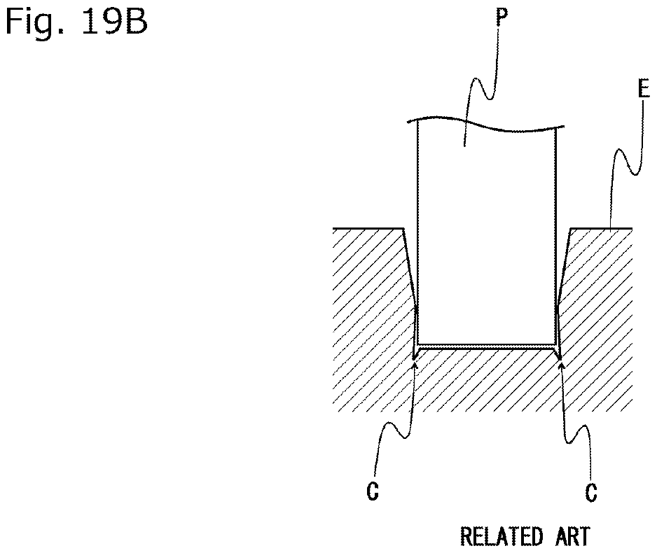

When each link plate of a chain passing around the sprocket 100 presses the cushion ring 120 as shown in FIG. 5A, the surface of the cushion ring 120 is stretched, as each of the circumferential grooves 125 is deformed as shown in FIG. 5B (for the sake of simplicity, only an inner link plate 151 is shown in FIG. 5A and FIG. 5B). Therefore, the amount of deformation (strain) L1 of the cushion ring 120 is smaller than the amount of deformation L0 of a cushion ring with a flat outer circumferential surface (see FIG. 19A), so that the stress generated in the cushion ring 120 is reduced. The load applied on the surface of the cushion ring 120 with repeated compression/deformation by the contact with the link plates of the chain and release/restoration is accordingly mitigated. Crack formation on the surface of the cushion ring 120 is thus avoided, so that the cushion ring 120 can exhibit its intended functions in a stable manner over a long period.

### Second Embodiment

The sprocket according to a second embodiment of the present invention is the same as that of the first embodiment except for the configuration of the cushion ring.

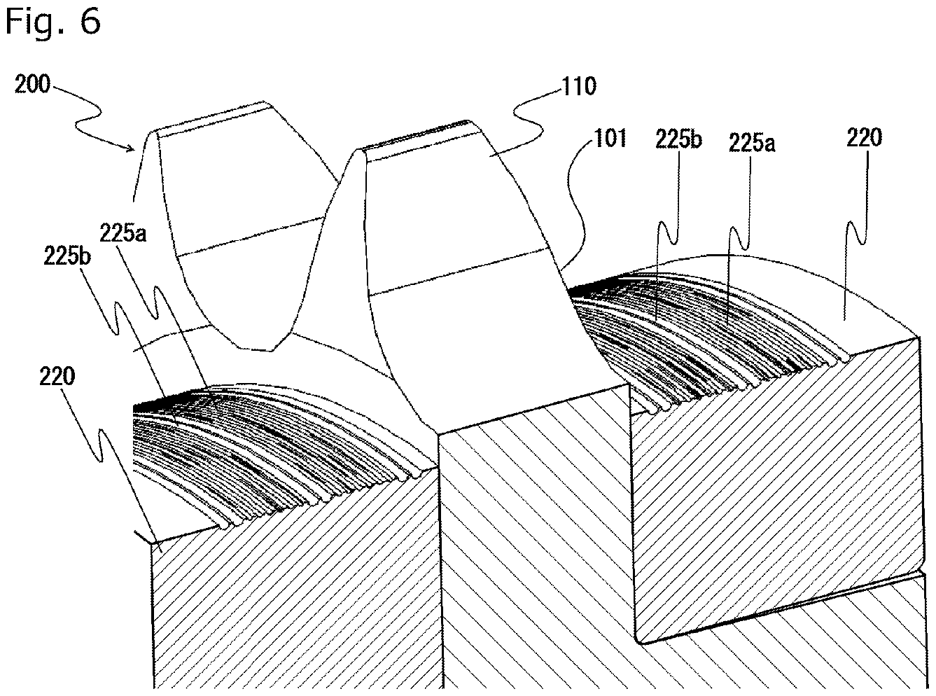

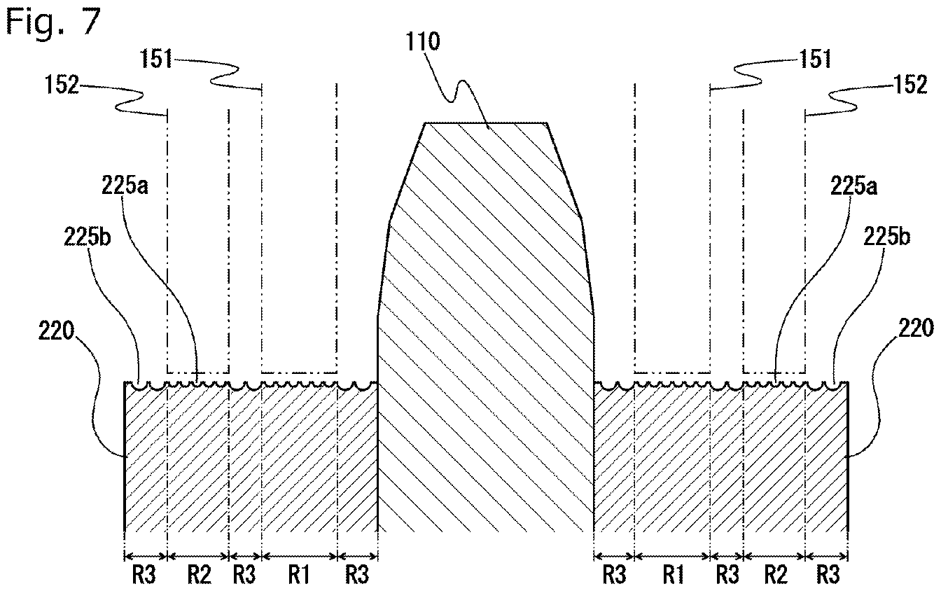

As shown in FIG. 6 and FIG. 7, a plurality of circumferential grooves 225a and 225b extend circumferentially and continuously all around and side by side in a width direction on the outer circumferential surface of the cushion rings 220 of the sprocket 200 of the second embodiment.

The plurality of circumferential grooves (hereinafter, “first circumferential grooves”) 225a respectively disposed in pressed regions R1 pressed by inner link plates 151 and pressed regions R2 pressed by outer link plates 152 of each of the cushion rings 220 have the same size (groove width and groove depth) and the same cross-sectional shape, for example, and are equally spaced in the width direction. While the first circumferential grooves 225a have a rounded cross section, they may be of any shape and may vary in form.

A plurality of (for example two) circumferential grooves (hereinafter, “second circumferential grooves”) 225b are provided close to each other in non-pressed regions R3 positioned on both outer sides in the width direction of the pressed regions R1 and R2 of each of the cushion rings 220. The second circumferential grooves 225b provided in the non-pressed regions R3 have the same size (groove width and groove depth) and the same shape, for example, but have a larger groove width and a larger groove depth than the first circumferential grooves 225a disposed in the pressed regions R1 and R2. While the second circumferential grooves 225b have a rounded cross section, they may be of any shape and may vary in form.

Since the plurality of second circumferential grooves 225b are provided at positions where the load on the surface of the cushion ring 220 is largest in this sprocket 200, and since each of the second circumferential grooves 225b has a larger size than the first circumferential grooves 225a, the amount of deformation (strain) of the cushion rings 220 caused by contact with each of the link plates 151 and 152 of the chain is reduced even more, so that crack formation on the outer circumferential surface of the cushion rings 220 can be avoided reliably.

In the sprocket 200 according to the second embodiment, the pair of cushion rings 220 provided on both side surfaces of the sprocket body 101 need not be formed with the first circumferential grooves 225a and the second circumferential grooves 225b in mirror symmetry around a center in the width direction. If the pair of cushion rings 220 are formed with the first circumferential grooves 225a and the second circumferential grooves 225b asymmetrically around a center in the width direction, timing at which the chain comes to hit (contact) the sprocket can be shifted so that the impact sound of the meshing can be dispersed.

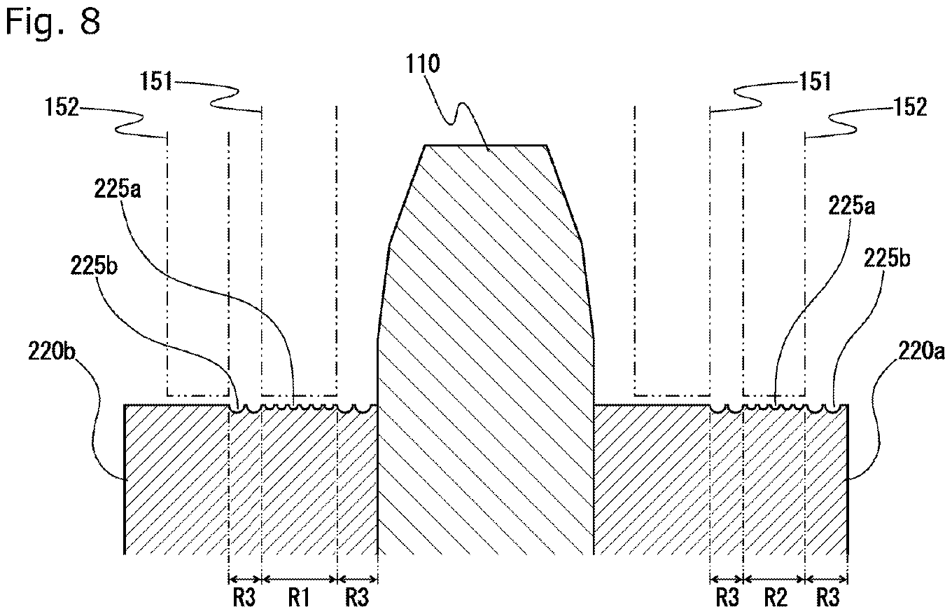

For example, as shown in FIG. 8, one cushion ring 220a may be formed with a plurality of first circumferential grooves 225a in the pressed region R2 pressed by outer link plates 152 side by side in the width direction, and a plurality of second circumferential grooves 225b close to each other in non-pressed regions R3 positioned on both outer sides in the width direction of the pressed region R2, while the other cushion ring 220b may be formed with a plurality of first circumferential grooves 225a in the pressed region R1 pressed by inner link plates 151 side by side in the width direction, and a plurality of second circumferential grooves 225b close to each other in non-pressed regions R3 positioned on both outer sides in the width direction of the pressed region R1.

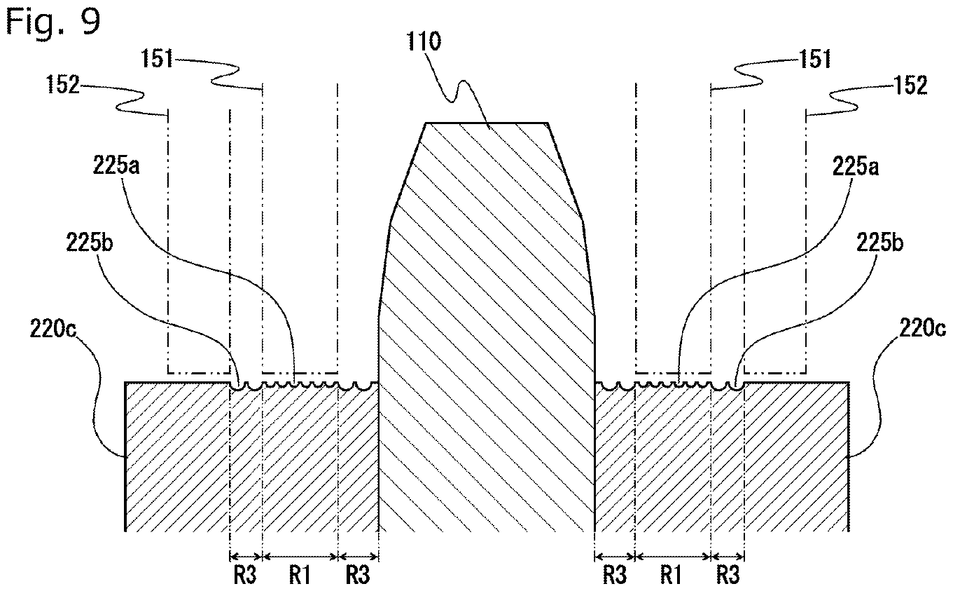

Or, as shown in FIG. 9, each of the cushion rings 220c may be formed with the first circumferential grooves 225a and the second circumferential grooves 225b respectively only in the pressed regions R1 pressed by the inner link plates 151 and the non-pressed regions R3 positioned on both outer sides of the pressed regions R1. Also, although not shown, circumferential grooves may be formed only in the pressed regions R2 pressed by the outer link plates 152 on the outer circumferential surface and the non-pressed regions R3 positioned on both outer sides of the pressed regions R2.

### Third Embodiment

The sprocket according to a third embodiment of the present invention is the same as that of the first embodiment except for the configuration of the cushion ring.

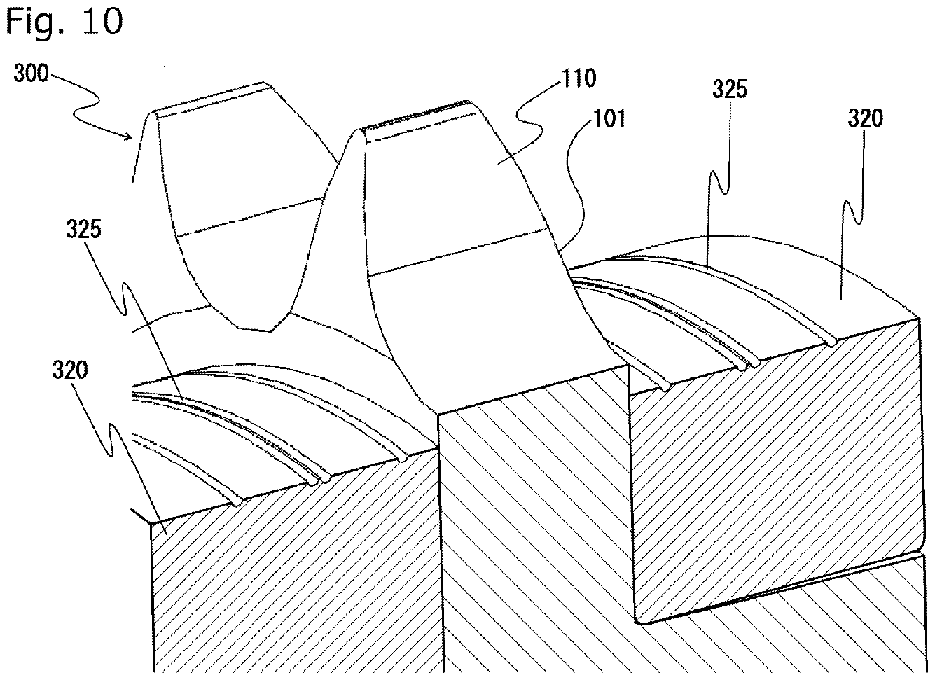

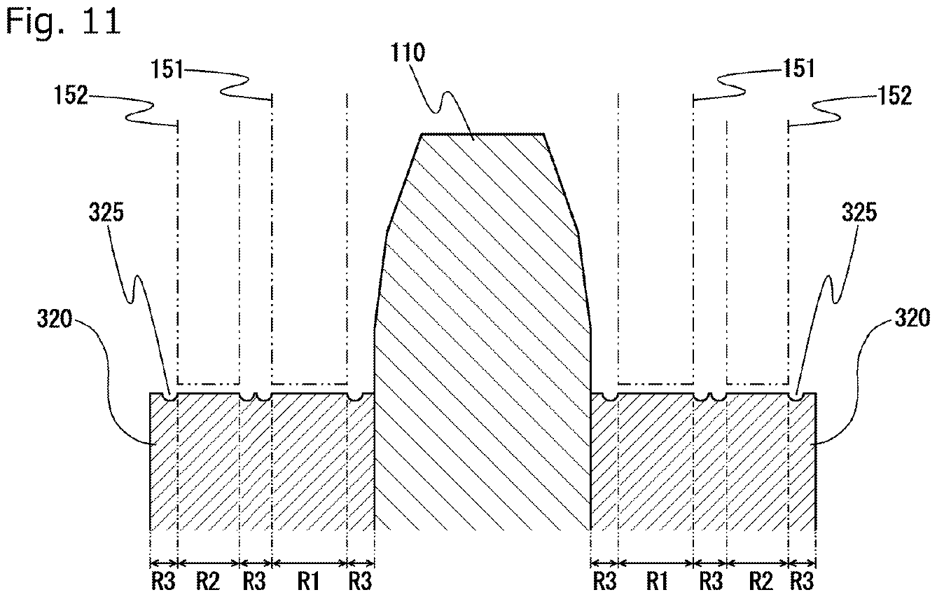

As shown in FIG. 10 and FIG. 11, the cushion rings 320 of the sprocket 300 according to the third embodiment of the present invention are formed with circumferential grooves 325 extending circumferentially and continuously all around in non-pressed regions R3 positioned on both outer sides in the width direction of pressed regions R1 pressed by the inner link plates 151, and in non-pressed regions R3 positioned on both outer sides in the width direction of pressed regions R2 pressed by the outer link plates 152, on the outer circumferential surface. The circumferential grooves 325 have a rounded cross section, for example, but may be of any shape.

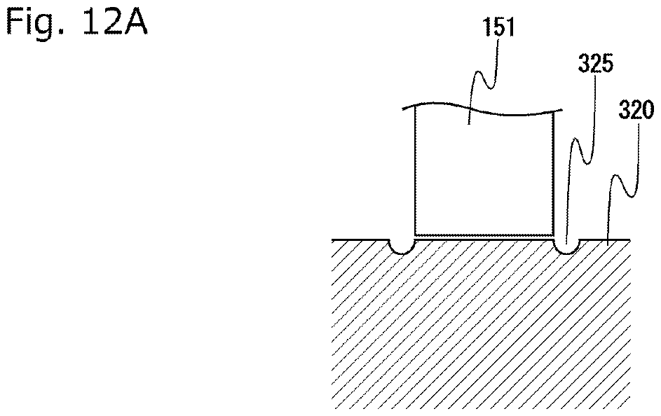

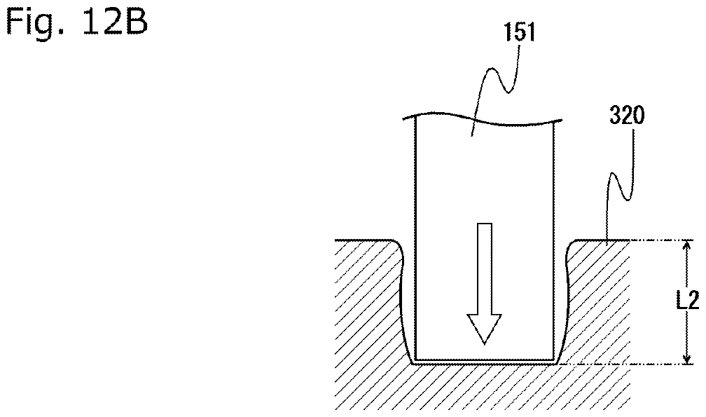

This sprocket 300 can also provide the same effects as the sprockets of the first and second embodiments, since the circumferential grooves 325 are positioned on the surface where the amount of stretch is large. Namely, when the link plate of the chain passing around the sprocket 300 presses the cushion ring 320 as shown in FIG. 12A, the surface of the cushion ring 320 is stretched, as the circumferential groove 325 is deformed as shown in FIG. 12B (for the sake of simplicity, only an inner link plate 151 is shown in FIG. 12A and FIG. 12B). Therefore, the amount of deformation (strain) L2 of the cushion ring 320 is smaller than the amount of deformation L0 of a cushion ring with a flat outer circumferential surface (see FIG. 19A), so that the stress generated in the cushion ring 320 is reduced.

The load applied on the surface of the cushion ring 320 with repeated compression/deformation by the contact with the link plates of the chain and release/restoration is accordingly reduced. Crack formation on the surface of the cushion ring 320 is thus avoided, so that the cushion ring 320 can exhibit its intended functions in a stable manner over a long period.

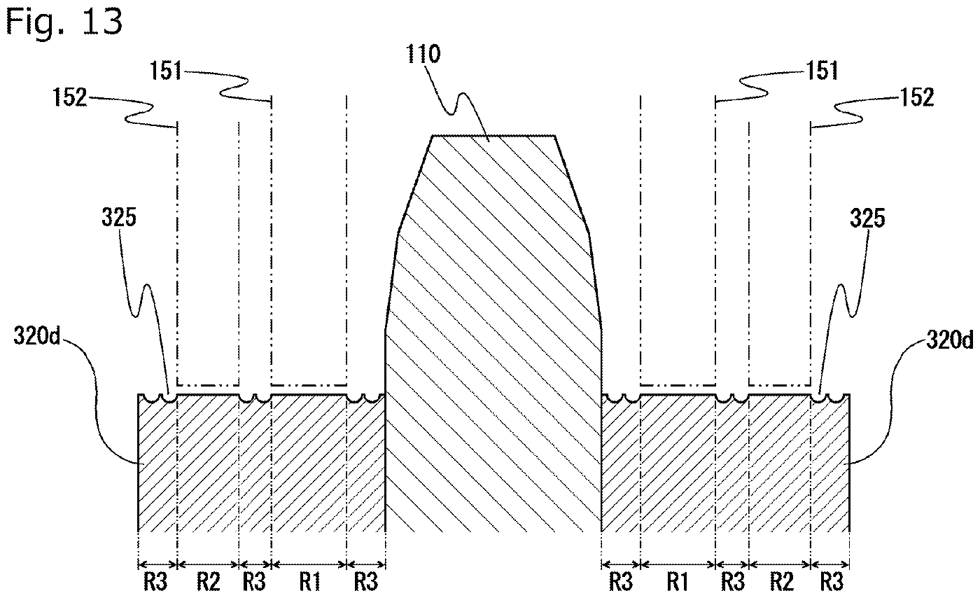

The number of the circumferential grooves 325 disposed in the non-pressed regions R3 of the sprocket 300 according to the third embodiment is not limited in particular. For example, there may be a plurality of circumferential grooves 325 in the non-pressed regions R3 as shown in FIG. 13. An increase in the number of the circumferential grooves 325 can reduce the amount of deformation (strain) of the cushion ring 320d when in contact with each link plate of the chain even further, so that crack formation on the outer circumferential surface of the cushion ring 320d can be avoided reliably.

The pair of cushion rings 320 provided on both side surfaces of the sprocket body 101 need not be formed with the circumferential grooves 325 in mirror symmetry around a center in the width direction in the sprocket 300 according to the third embodiment.

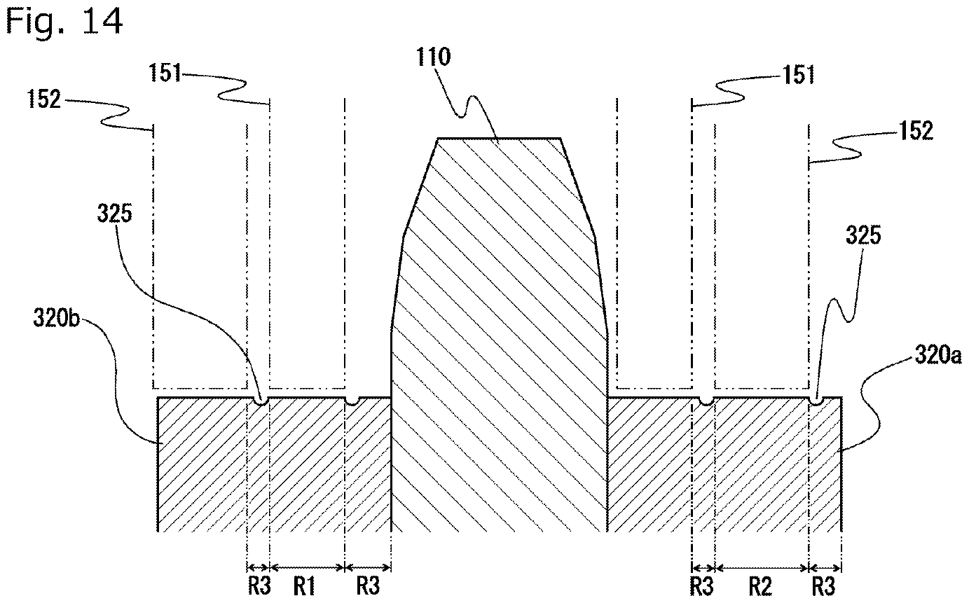

For example, as shown in FIG. 14, one cushion ring 320a may be formed with circumferential grooves 325 in the non-pressed regions R3 positioned on both outer sides in the width direction of a pressed region R2 that is pressed by outer link plates 152, while the other cushion ring 320b may be formed with circumferential grooves 325 in the non-pressed regions R3 positioned on both outer sides in the width direction of a pressed region R1 that is pressed by inner link plates 151.

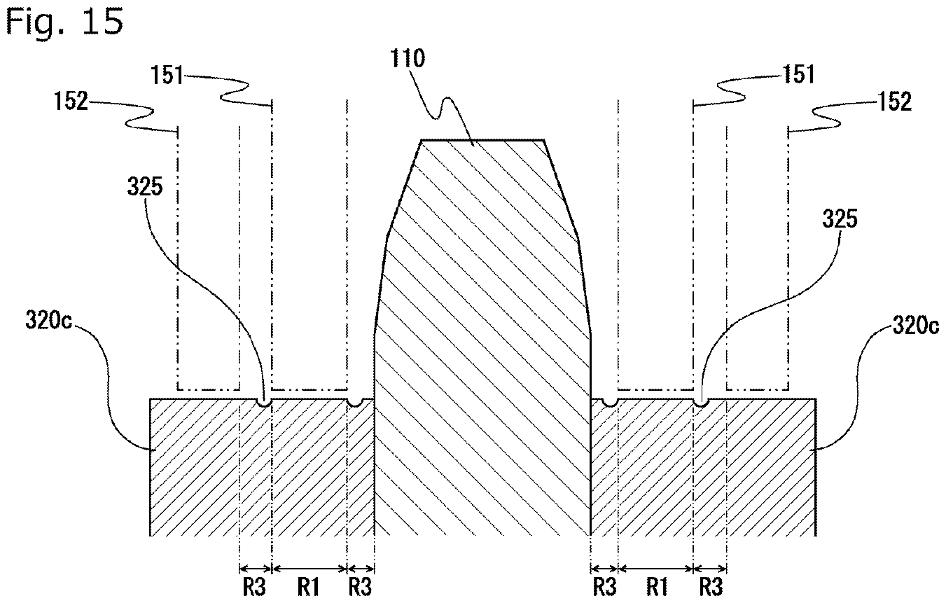

Alternatively, as shown in FIG. 15, each of the cushion rings 320c may be formed with circumferential grooves 325 only in the non-pressed regions R3 positioned on both outer sides in the width direction of pressed regions R1 that are pressed by inner link plates 151. Also, although not shown, the circumferential grooves 325 may be provided on the outer circumferential surface only in the non-pressed regions R3 positioned on both outer sides in the width direction of pressed regions R2 that are pressed by outer link plates 152.

### Fourth Embodiment

The sprocket according to a fourth embodiment of the present invention is the same as that of the first embodiment except for the configuration of the cushion ring.

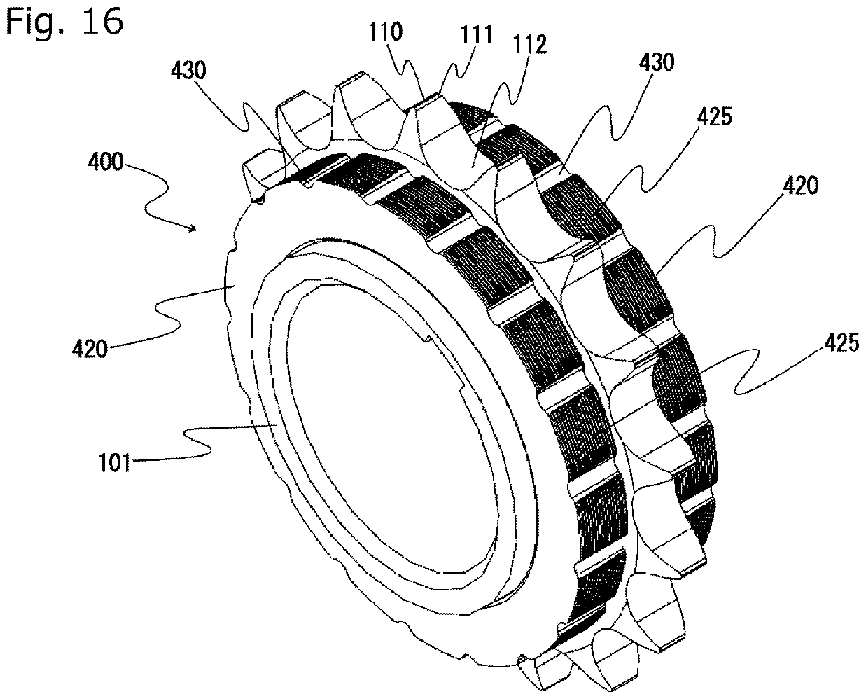

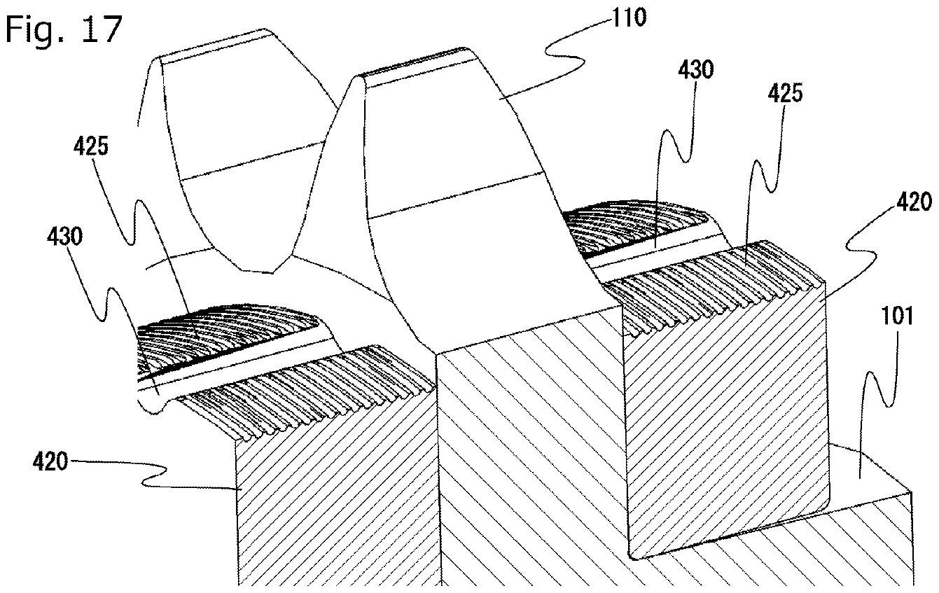

As shown in FIG. 16 and FIG. 17, cushion rings 420 of the sprocket 400 according to the fourth embodiment include a plurality of non-cylindrical parts in the outer circumferential surface having a radius different from that of other parts. The non-cylindrical parts are formed by crossing grooves 430 extending in the width direction and formed at the same pitch as that of the plurality of teeth 110 of the sprocket body 101. More specifically, in the circumferential surface of the cushion rings 420, the crossing grooves 430 are provided at positions corresponding to the tooth bottoms 112 of the plurality of teeth 110 of the sprocket body 101. The “corresponding positions” in the circumferential direction herein refer to the same angular positions in the circumferential direction of the sprocket 400.

A plurality of circumferential grooves 425 extend circumferentially on the outer circumferential surface portions (at positions corresponding to the plurality of tooth tips 111) positioned between adjacent crossing grooves 430 on the outer circumferential surfaces of the cushion rings 420. The plurality of circumferential grooves 425 have the same size (groove width and depth) and the same shape, for example, and are equally spaced in the width direction. While the circumferential grooves 425 have a rounded cross section, they may be of any shape and may vary in form.

In the sprocket 400 according to the fourth embodiment, a plurality of crossing grooves 430 may be provided at positions corresponding to the tooth bottoms 112 of the plurality of teeth 110 of the sprocket body 101.

### Fifth Embodiment

The sprocket according to a fifth embodiment of the present invention is the same as that of the first embodiment except for the configuration of the cushion ring.

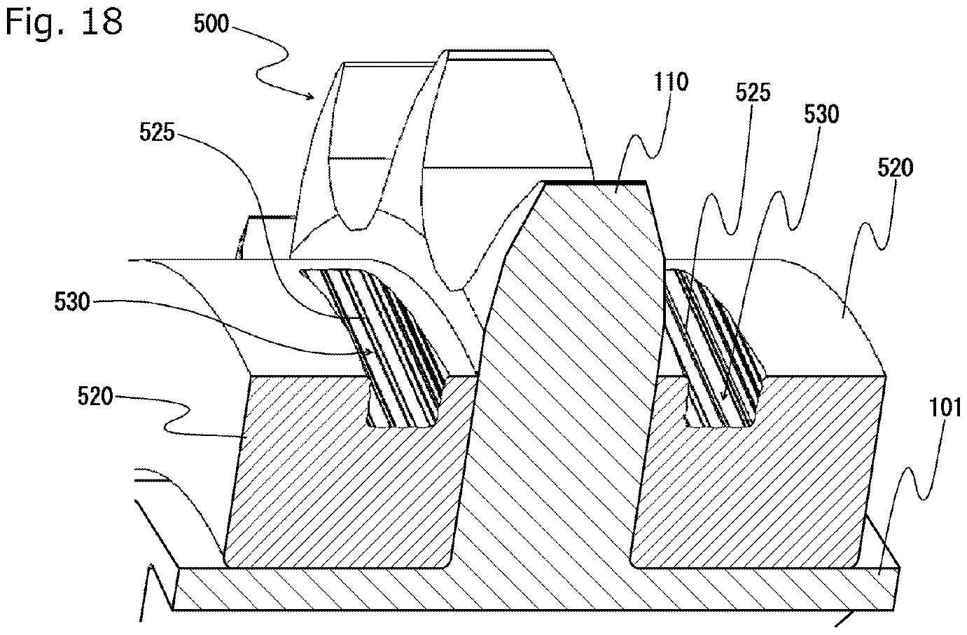

As shown in FIG. 18, the cushion rings 520 of the sprocket 500 according to the fifth embodiment are formed with a plurality of recesses 530 extending intermittently in the circumferential direction at positions where inner link plates of the chain will contact in the width direction of the cylindrical outer circumferential surface, i.e., such that the recesses are each positioned correspondingly to the plurality of teeth 110 of the sprocket body 101. Circumferential grooves 525 are provided on the surface of each recess 530 such as to extend in the circumferential direction. There are a plurality of circumferential grooves 525 both in the width direction and in the radial direction.

In this embodiment, the cushion rings 520 have a smooth, continuous waving surface.

In the sprocket 500 according to the fifth embodiment, the recesses 530 may be formed such as to extend all around in the circumferential direction.

The recesses with circumferential grooves on the surfaces thereof may be provided on the outer circumferential surface of each of the cushion rings 520 at positions where the cushion rings will contact the outer link plates.

Alternatively, one of the cushion rings may be provided with recesses at positions on the outer circumferential surface where it will contact the outer link plates, while the other cushion ring may be provided with recesses at positions on the outer circumferential surface where it will contact the inner link plates (asymmetric configuration around a center in the width direction).

As described above, the sprocket of the present invention reduces the impact or knocking sound of contact when meshing with the chain and brings immense merits such as less local degradation of cushion rings, less vibration and noise of an entire chain drive system, improved durability of the system, and so on.

What is claimed is:

1. A sprocket comprising a sprocket body having a plurality of teeth formed on a circumferential surface thereof, and a cushion ring provided on at least one side surface of the sprocket body and having an outer circumferential surface that is configured to come into contact with link plates of a chain,
the cushion ring including a circumferential groove extending in a circumferential direction on the outer circumferential surface, the circumferential groove having a width smaller than that of the link plates.

2. The sprocket according to claim 1, wherein a plurality of the circumferential grooves are formed in a width direction of the cushion ring.

3. The sprocket according to claim 1, wherein the circumferential grooves include at least circumferential grooves provided in non-pressed regions on both outer sides of a pressed region that is configured to be pressed by the link plates.

4. The sprocket according to claim 3, wherein a plurality of the circumferential grooves are disposed in the non-pressed regions, and
the plurality of circumferential grooves disposed in the non-pressed regions include circumferential grooves that are disposed close to each other.

5. The sprocket according to claim 2, wherein the circumferential grooves are formed over an entire area in a width direction of the cushion ring.

6. The sprocket according to claim 3, wherein the circumferential grooves are disposed in each of the pressed region and the non-pressed regions, and the circumferential grooves disposed in the non-pressed regions are larger in at least one or both of a groove width and a groove depth than the circumferential grooves disposed in the pressed region.

7. The sprocket according to claim 1, wherein the cushion ring includes the outer circumferential surface having a plurality of non-cylindrical parts that have a radius different from that of other parts of the outer circumferential surface,
the plurality of non-cylindrical parts are provided with a same pitch as that of the plurality of teeth,
the non-cylindrical parts provided at portions corresponding to tooth tips of the plurality of teeth in the circumferential direction have a radius smaller than that of the other parts of the outer circumferential surface, and
the circumferential grooves are provided at least outer circumferential parts positioned between the non-cylindrical parts, the outer circumferential parts having a cylindrical shape.
